(19) United States
(12) Patent Application Publication
(10) Pub. No.: US 2003/0200173 A1
(43) Pub. Date: Oct. 23, 2003

(54) Personalized bill information request with short message service

(75) Inventor: Jen-chun Chang, Taipei (TW)

Correspondence Address: Ladas & Parry, Suite 2100, 5670 Wilshire Boulevard, Los Angeles, CA, 90036, US

(73) Assignee: BENQ CORPORATION

(21) Appl. No.: 10/418,833

(22) Filed: Apr. 17, 2003

(30) Foreign Application Priority Data
Apr. 18, 2002 (TW) 91107973

(51) Int. Cl. G06F 17/60

(52) U.S. Cl. 705/40

(57) ABSTRACT

A method for requesting personalized bill information with a short message service. A mobile communication system comprises a mobile station (MS), a service center (SC) having a bill information database, wherein matching a bill information request with the bill information database to construct a personalized bill information and transmitting a short message including the personalized bill information to the MS, and a plurality of bill information types in the bill information database; and a method for requesting personalized bill information with a short message service, comprising the steps of constructing a personalized bill information request on the MS, transmitting bill information request from the MS to the SC, constructing a personalized bill information response by accessing the bill information database according to the personalized bill information request, and transmitting the personalized bill information response from the SC to the MS.

### BACKGROUND OF THE INVENTION

1. Field of the Invention

The present invention relates in general to a method for requesting personalized bill information with a short message service. In particular, the present invention relates to a method utilizing short message service to transmit a request for the bill information personalized by an individual user.

2. Description of the Related Art

As communication networks improve with time, the mobile phone has become one of the most common personal communication devices. Because of the popularity of mobile phones, their design is not purely functional, but also takes into consideration the demands and feelings of the user to give the product a friendly user interface. Also, while telecom companies provide voice communication service, in today's competitive market, other value-added services such as short message service (SMS) should also be provided. SMS is currently one of the most widely used services.

In SMS, a small amount of data is transmitted per use. The SMS broadcast service allows a short message to be delivered to all the users in a specific area. Point-to-point SMS transmits a message to a specific user. Telecom companies can utilize SMS by sending weather forecasts stock reports, and bill reminders to their customers.

For example, the telecom services can utilize SMS at fixed time intervals to send a user SMS bill information. User bill information contains a plurality of fixed bill information types as established by telecom companies, for example, the number of calls dialed, the number of SMS messages sent, and the total fee, etc. However, the user can only passively wait for the telecom services to provide the bill information. He or she can not actively request his or her own bill information. Furthermore, he or she can not request the type of bill information he or she wants, such as the number of calls dialed, the number of SMS messages sent, and the total amount due.

### SUMMARY OF THE INVENTION

An object of the present invention is a method for requesting personalized bill information with SMS from a mobile station and utilizing short message service to transmit a request for the bill information personalized by an individual user.

The present invention provides a method for requesting personalized bill information with short message service. The telecom company receives a bill information request from a user. A bill information model is provided by the telecom company and the model is saved on the SIM card. The Subscriber Identity Module Application Tool Kit (SIM Tool Kit or STK) is utilized to access the bill information database, which is established by the telecom companies. The bill information database contains different types of bill information. The method of this invention comprises the steps as follows. According to each bill information request, the personalized bill information is obtained from a bill information database by matching the bill information request with the types provided in the database, and a short message including the personalized bill information is transmitted to the mobile station (MS). The predetermined bill information comprises at least one bill information display mode, such as text mode or graphic mode. Furthermore, the short message is transmitted by short message service (SMS), enhanced messaging service (EMS), or multimedia messaging service (MMS).

### BRIEF DESCRIPTION OF THE DRAWINGS

The present invention can be more fully understood by reading the subsequent detailed description in conjunction with the examples and references made to the accompanying drawings, wherein:

FIG. 1a is a flow chart showing a method for requesting personalized bill information with short message service;

FIG. 1b is a flow chart following the steps of FIG. 1a;

FIG. 2 is a schematic diagram of the flow chart according to FIG. 1;

FIG. 3a is a schematic diagram illustrating the procedure of selecting bill information types as an example in the embodiment;

FIG. 3b is a schematic diagram illustrating a mobile phone receiving the personalized bill information and displaying the personalized bill information after completion of the process of FIG. 3a.

### DETAILED DESCRIPTION OF THE PREFERRED EMBODIMENT

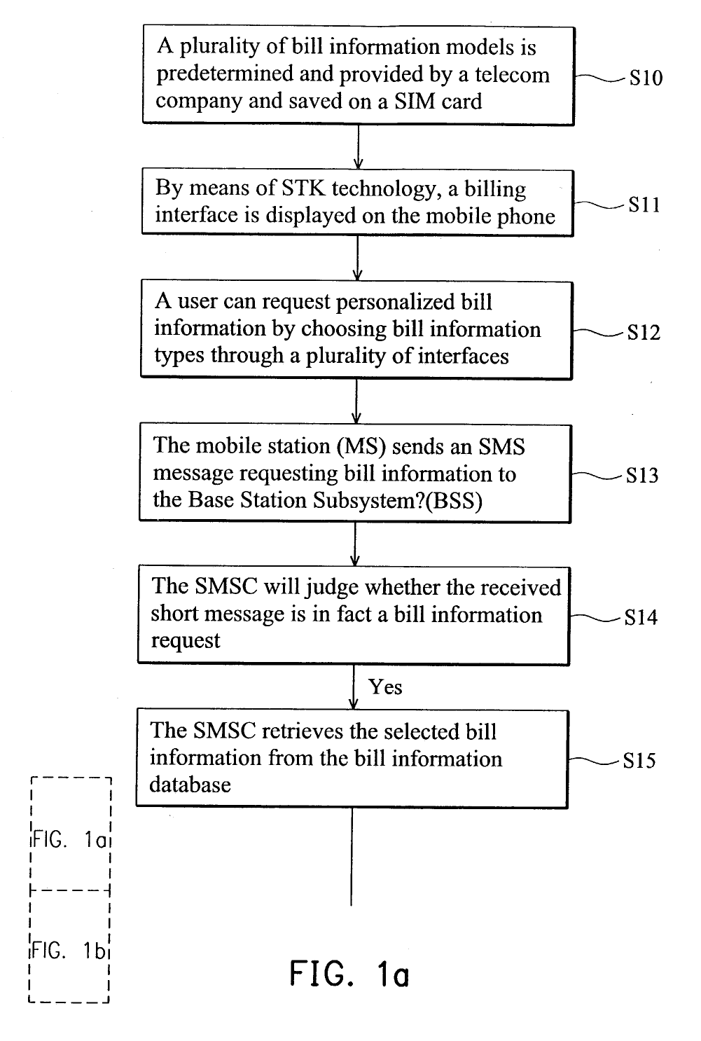

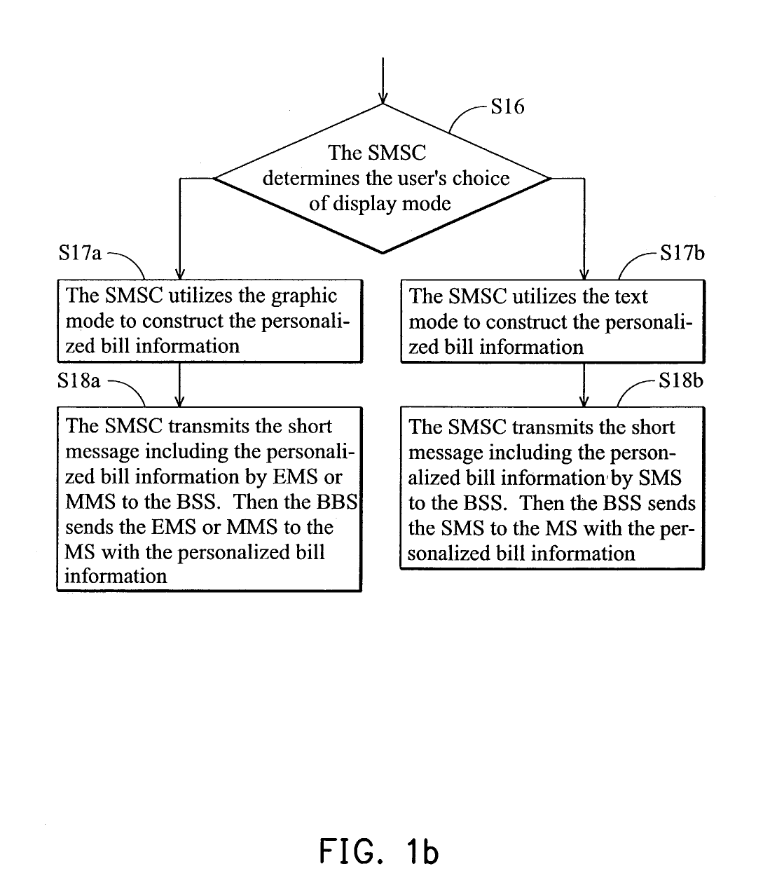

FIGS. 1a and 1b illustrate a flow chart showing a method for requesting personalized bill information with short message service. As shown in FIG. 1a, a plurality of bill information models is predetermined and provided by a telecom company and saved on a SIM card (S10). One of the bill information models is utilized by the SIM card according to the type of mobile station (MS) or mobile phone. The model comprises a plurality of bill information types. Moreover, by means of STK technology, a billing interface is displayed on the mobile phone (S11). A user can request personalized bill information by choosing bill information types through a plurality of interfaces (S12). In the embodiment of this invention, in step S12, the interfaces comprise a billing interface showing functions such as get bill info, a billing information personal interface showing bill information types, and a mode selection interface showing display modes. A plurality of display modes are provided by the bill information model. The display modes comprise a text mode and a graphic mode. Therefore, in step S12, the user can select one of the display modes mentioned above (text or graphic mode) through the mode selection interface. This bill information mode is also included in the bill information request.

First, the mobile station (MS) sends an SMS message requesting bill information to the Base Station Subsystem (BSS) (S13). The BSS passes the bill information request to the SMS center (SMSC). The SMSC will judge whether the received short message is in fact a bill information request (S14). If yes, the SMSC retrieves the selected bill information from the bill information database (S15).

Lastly, the SMSC transmits a short message containing the personalized bill information to the MS. This step is implemented according to the display mode selected in the bill information request. Thus, before executing this step, the SMSC determines the user's choice of display mode (S16) as shown in FIG. 1b. If the user selects the graphic mode as the display mode, then the SMSC utilizes the graphic mode to construct the personalized bill information (S17a). Next, the SMSC transmits the short message including the personalized bill information by EMS or MMS to the BSS. Finally, the BSS sends the EMS or MMS to the MS with the personalized bill information, where it is displayed (S18a). On the other hand, if the user selects the text mode as the display mode, then the SMSC utilizes the text mode to construct the personalized bill information (S17b). Next, the SMSC transmits the short message including the personalized bill information by SMS to the BSS. Finally, the BSS sends the SMS to the MS with the personalized bill information, where it is displayed (S18b).

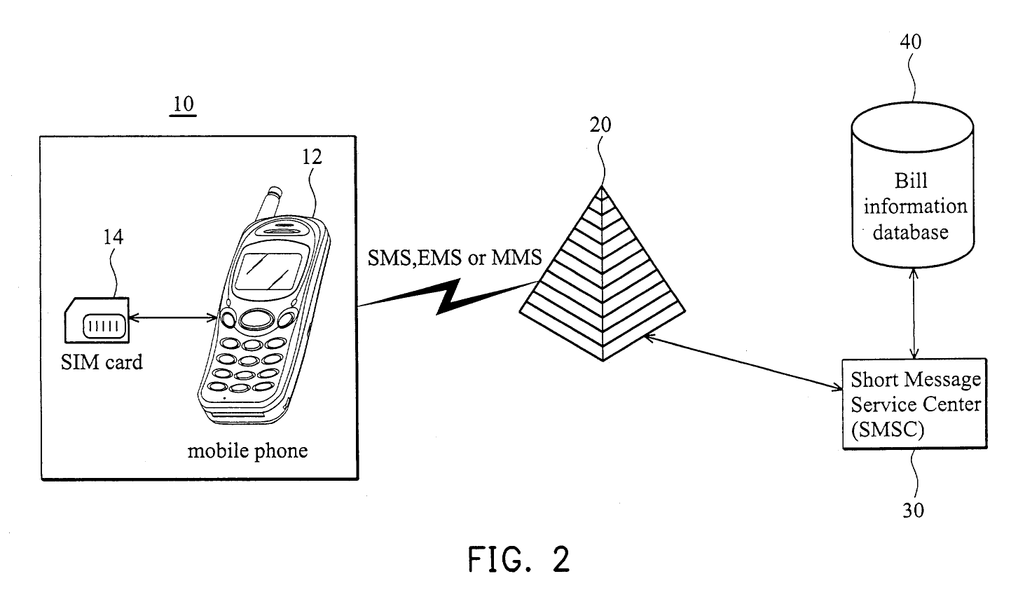

FIG. 2 is a schematic diagram of the flow chart according to FIG. 1. As shown in the figure, a mobile phone (10) consists of a hand held unit (12) and a SIM card (14). The user must use a mobile phone (10) compatible with STK functions so that he or she can enjoy the enhanced services. A bill information database (40) is also established. The database (40) contains all bill information types. All the information in the database (40) can be retrieved by the SMSC (30). In the present invention, the enhanced services and a plurality of bill information models are provided in the SIM card (14) by telecom companies. A start command (not shown in the figure) is provided in order to open the billing interface as mentioned in step S12 in FIG. 1a. In this embodiment, after a user selects the function of bill info setting in the billing interface, the bill information personal interface is opened and a plurality of bill information types is shown on the screen of the mobile phone (10). After the bill information request is set through the bill information personal interface, the mobile phone (10) sends the request with a short message to the BSS (20) and the BSS passes the short message to the SMSC (30). The SMSC (30) judges whether the short message contains the bill information request. If it does, the SMSC retrieves the selected bill information from the bill information database (40) based on the bill information request to construct personalized bill information (S15).

After the personalized bill information is constructed, the SMSC (30) transmits the personalized bill information with a short message with the personalized bill information via the BSS (20) back to the mobile phone (10). Finally, the screen of the cellular phone displays the personalized bill information.

In the present invention, the provided bill information models further contain a plurality of display modes. In this embodiment, the display modes provided by the mobile phone comprise a text mode and a graphic mode. Thus, a user can select one of the display modes as mentioned above (text or graphic mode) from the billing interface. The selected display mode is included in the bill information request.

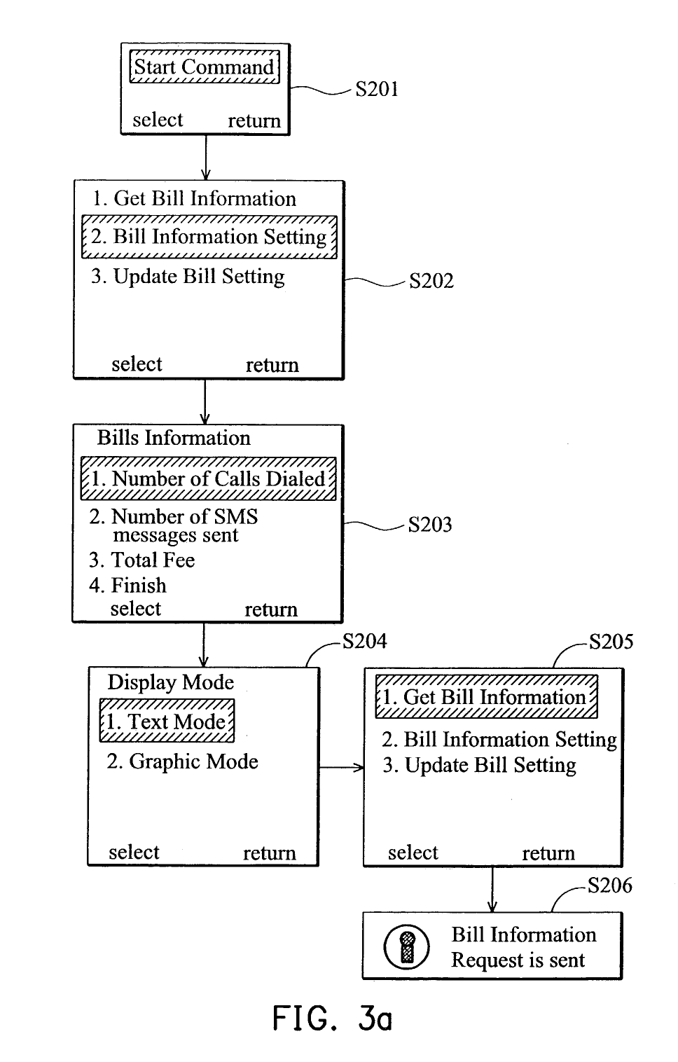

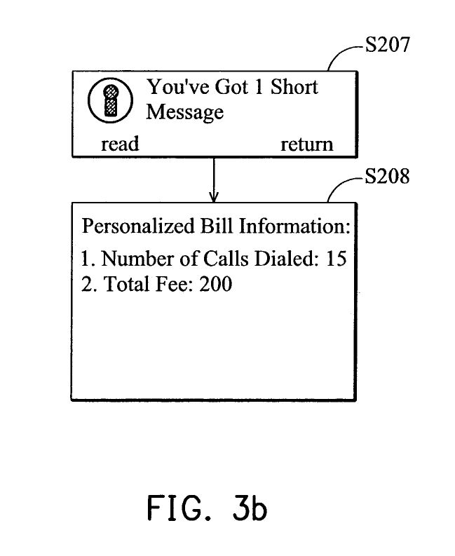

The following example illustrates the procedure of selecting the bill information types. FIG. 3a is a schematic diagram illustrating the procedure of selecting the bill information types as an example of the embodiment. As shown in the figure, first, the user selects a start command (S201).

After the start command is selected, the mobile phone enters the billing interface. In this embodiment, the screen of the mobile phone shows three functions for users to select as follows:

(1) Get bill information: Selecting this option causes a bill information request to be sent out with a short message.

(2) Bill information Setting: Selecting this option allows a user to choose the bill information types from the bill information personalization interface.

(3) Update Bill Setting: Every month telecom service will send bill information to each user. Selecting this option allows a user to receive the updated bill information between normal billing periods.

In step (S202), the mobile phone opens the billing interface and the screen shows the three selections. In this example, the user selects the “Bill Information Setting”.

Next, the mobile phone opens the bill information personal interface and the screen displays four format selections as follows: (1) Number of Calls Dialed; (2) Number of SMS messages sent; (3) Total Fee; (4) Finish. In this example, the user selects the “Number of Calls Dialed” and “Total Fee” (S203).

After the user selects the necessary bill information types, the user selects the display mode. The screen of mobile phone shows two selections as follows: (1) text mode; (2) graphic mode. In this example, the user selects text mode as the display mode (S204).

When the user completes selecting the bill information types, the screen of mobile phone returns to the billing interface. The user then selects the “Get bill information” function (S205). After the function is selected, the bill information request is transmitted with a short message. At this time, the screen shows the message of “Bill information request is sent” (S206).

FIG. 3b is a schematic diagram illustrating a mobile phone receiving and displaying the personalized bill information after completion of the process of FIG. 3a. After the bill information request is sent with the short message, a second short message including the personalized bill information is sent back to the mobile phone from the SMSC via the BSS. Since the selected display mode is text mode, the SMSC will first construct the personalized bill information using text mode, and then send a SMS to the BSS. The BSS sends the SMS including the personalized bill information back to the mobile phone. The mobile phone will receive the short message containing the personalized bill information in a few seconds. At that time, the screen of the mobile phone shows “You've got 1 short message”. The user can select and read the short message (S207). In this case, the screen displays a message such as “Personalized bill information: (1) Number of Calls Dialed: 15; (2) Total Fee: 200” (S208).

In conclusion, the present invention allows a user to select and obtain his or her personalized bill information. Also according to the display mode selected, the personalized bill information is sent back to the MS and is displayed on the screen.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for transmitting a bill information to a mobile station (MS), the method comprising the steps of:
constructing a personalized bill information request on the MS; matching the bill information request with a bill information database to construct the personalized bill information; and
transmitting a short message including the personalized bill information to the MS.

2. The method of claim 1 wherein the MS contains a SIM card, which provides a plurality of bill information types.

3. The method of claim 1 wherein the bill information types include a plurality of display modes.

4. The method of claim 3 wherein the bill information display mode is a text mode.

5. The method of claim 3 wherein the bill information display mode is a graphic mode.

6. The method of claim 1 further comprising a step after asking a bill information request from the MS;
transmitting the bill information request with a short message to a Short Message Service Center (SMSC).

7. The method of claim 6 wherein the bill information request is transmitted via an Enhanced messaging service.

8. The method of claim 6 wherein the bill information request is transmitted via a Multimedia messaging service.

9. The method of claim 1, wherein the step of constructing a personalized bill information includes providing a personal interface to set up the personalized bill information.

10. The method of claim 9, wherein the personal interface includes a number of format selections.

11. The method of claim 1 wherein the bill information database is provided by the SMSC p.

12. The method of claim 1 wherein the mobile station is a mobile phone.

13. The method of claim 1 wherein the mobile station is a Personal Digital Assistant (PDA).

14. The method of claim 1 wherein the wherein the mobile station is a Palmtop PC.
